(19) United States
(12) Patent Application Publication
(10) Pub. No.: US 2018/0132426 A1
(43) Pub. Date: May 17, 2018

(54) WAXED FLOWER BULB, METHOD AND DEVICE FOR WAXING A FLOWER BULB

(71) Applicant: HIJDRA RETAIL SERVISES B.V., BERKEL EN RODENRIJS (NL)

(72) Inventor: Petrus Johannes Cornelus HIJDRA, BERKEL EN RODENRIJS (NL)

(73) Assignee: HIJDRA RETAIL SERVISES B.V., BERKEL EN RODENRIJS (NL)

(21) Appl. No.: 15/810,225

(22) Filed: Nov. 13, 2017

(30) Foreign Application Priority Data
Nov. 11, 2016 (NL) 1042141

(51) Int. Cl. A01G 7/00; A01N 3/00; C09D 191/06; A01G 13/00; A01G 22/35; A01G 22/60

(52) U.S. Cl. CPC A01G 7/00; A01N 3/00; A01G 22/60; A01G 13/00; A01G 22/35; C09D 191/06

(57) ABSTRACT

The invention relates to a flower bulb, a method, as well as device for providing flower bulbs with a layer of sealant, such as a paraffin of wax layer, wherein the bulb is grabbed, i.e. engaged by a suction cup, which bulb is brought into immersion of sealant such that at least the seized part of the bulb remains free of sealant. The immersion device is provided with a turning mechanism wherein one or more suction cups have been included for receiving flower bulbs, which suction cups are contained in, and connected to one or more of hollow carriers, which device further comprises an air pump for evacuating the suction cups, said suction cups for this purpose are via said hollow container included in pneumatic communication with an air pump, and which compound comprises a swivel coupling for pneumatically connecting via a conduit or holder part, the hollow container with a fixed central pneumatic line connected to an air pump.

### BACKGROUND OF THE INVENTION

The present invention relates to a flower bulb, in particular a relatively small bulb such as a hyacinth, tulip or daffodil, as well as to a method and a device for waxing flower bulbs.

### DESCRIPTION OF THE RELATED ART

Waxed bulbs are generally known and can be obtained at relatively high price in a shop, at the market or online. For the purpose of the wholesaler, such as on http://www.kebol.nl/home-and-garden/wax, such waxed bulbs are described as “ . . . with added value . . . suitable for a wide distribution channel”. This refers, amongst others, to the colorfulness that can be given to the bulbs via the wax layer, so that they already form a colorful and thus decorative whole on a table or in a glass container already before and during the bulb's emergence. An illustration of this is given by the article “dipped in wax Amaryllis conquers living room”, as published in http://www.groenvandaag.nl/wax-amaryllis-huiskamer/ on 10 Nov. 2015.

Methods for preservation of ornamental plants, or at least for wax dipping of products, are equally well known, for example as a form of special home crafts. Examples hereof are “How to preserve flowers with wax”, published on 28 Jan. 2016 in https://www.youtube.com/watch?v=E9Q-pGJTqhY, and “Impressie herfstworkshop waxen” (English: impression fall workshop waxing) published by Elly Schreapen on 12 Oct. 2012 in https://www.youtube.com/watch?v=R2F5V3qcJ4U&t=4s. According to this known method, ornamental products can be, after immersion in liquid paraffin followed by cooling in a water bath, provided with a preserving wax coating, possibly with colors, and styled floral arrangements can correspondingly be obtained.

In commerce the coloring of bulbs is found to be especially of importance when it comes to flower arrangements with bulbs that are still to sprout. Not exclusively, but especially in the run-up to heydays, such colored and decorated flower bulbs can be offered for exceptionally high prices.

A disadvantage of known paraffin treatments is that they are only suitable for the Amaryllis bulb, or so it seems. It appears that in practice the use of the known method of waxing with several other bulbs such as the tulip, daffodil and hyacinth, too often leads to the outbreak of mold, or—unlike with the Amaryllis—a non-fully flowering plant. This disadvantage is all the more of relevance to the flower trade, because the category of bulbs that is now considered “vulnerable to waxes” is relatively large.

### BRIEF SUMMARY OF THE INVENTION

The present invention therefore aims to overcome this problem to a large extend, and to achieve a waxed bulb such that also the existing flower bulbs in the category of “vulnerable to waxing” can be offered with added value, i.e. waxed and “colorful and beautiful” to the consumer without or at least with strongly reduced risk of deterioration, as well as with expected certainty of full sprouting of the bulb.

Furthermore, the invention includes a novel method to arrive at a waxed bulb according to the invention, as well as a device such as machine by which flower bulbs in general, and bulbs of fragile species in particular, may be provided with a wax or paraffin layer on an industrial, and in particular in an according to the invention correct manner.

Hereto, according to the present invention, flower bulbs, including bulbs of vulnerable flower bulb plants, are not completely immersed in the usual way, but the lower part of the bulb, in particular the root area of the bulb, is at least partially, preferably to a large extent not covered by wax. The waxed bulb according to the invention, therefore, exhibits at least near the root zone thereof, a zone that is kept free from wax. An underlying insight to this new waxed bulb is that relatively large bulbs like the amaryllis have sufficient nutrition to arrive at full growth by itself, in particularly without a need for rooting of the bulb. It has been found that the so-called “sensitive to wax” type of bulbs are typically relatively small compared to the amaryllis bulb, so that, as far as it has come to growth at all, this normally involves only a so-called emergency bloom. However, a bulb waxed or dipped in the paraffin according to the invention is capable of rooting, as is desired for relatively small bulbs according to the invention, and as a result having those nutrients, for example from soil, to achieve that “from the beautiful colors of the wax” at least with a higher degree of certainty the consumer's expected full bloom will be attained.

According to a further aspect of the present invention, a novel method includes that a bulb when immersed in or poured with paraffin, at least substantially near the lower part, at least in the root zone, is grabbed or supported in a manner covering against paraffin by holding means such as a suction cup or a supporting ring, thereby keeping this root part uncoverable by or free from the wax or paraffin.

More specifically, the invention includes a method for providing flower bulbs with a layer of sealant, such as a paraffin layer, wherein the bulb is grabbed by a grabbing means, such as being gripped with the aid of a suction cup or being supported by a ring, e.g. the upper end of a cylinder, which bulb is brought into immersion with sealant which remains at least at the grabbed portion of the bulb free of sealant. Hereby the bulb is grabbed or supported such that at least a part, preferably the major part, of the bulb's root zone remains free from sealant when immersed. Immersed with sealant in the context of this invention means that the bulb is either submerged in, immersed by or with, or flooded with sealant like wax.

The suction cup is preferably connected to a mechanical suctioning of air, in particular an air pump creating an under pressure. Thereby, a bulb can be applied manually or mechanically to a suction cup. In case of a root zone receiving cylinder, the latter is connected up right to a revolving, i.e. returnable gauze-shaped industrial belt.

In particular for the purpose of industrial application, at least in use in and around horticultural enterprises and businesses in the follow-up chain thereof to market, the invention comprises a method wherein the bulb and suction cup, with the aid of a turning mechanism, for the purpose of immersion are jointly turned in the sealant such that the bulb is pulled upside down through the bath, at least submerged therein. The bulb is caught by a soft surface, falling loose due to interruption of the air suction. The soft surface is formed by, at least the catching occurs preferably with, water. The turning mechanism may thereby be formed by a relatively simple, served by one or more people, manually operated rotary mechanism, or alternatively be formed as a relatively complex, for example electrically driven mechanism.

For said catching by a soft surface and after immersion in paraffin, a bulb according to the invented method is under continuous grip by the suction cup brought into immersion with cooling water. This is preferably done with a plurality of bulbs axially next to each other, at least axially offset bulbs contained in the turning mechanism at the same time. Accordingly, the invention also comprises a method according to the claims, wherein up to the reaching of the sealant of a supplied bulb by turning in the turning mechanism, multiple bulbs are disposed in the mechanism radially or tangentially.

The process according to the invention is ideally carried out by an immersion machine which is provided with a turning mechanism wherein one or more suction cups have been included for receiving flower bulbs, which suction cups are contained in and connected to one of one or more of hollow holders, which machine further includes an air pump for the purpose of evacuating the suction cups, which suction cups are for this purpose included in pneumatic connection with the air pump via said hollow holder, and which connection comprises a pivot coupling for pneumatically connecting the hollow holder via a pipe or holder part to a fixed central pneumatic conduit that is connected to the air pump.

### DESCRIPTION OF THE DRAWINGS

The invention will now by way of example be explained in more detail with reference to figures:

FIG. 1 is a photographic representation of commercially well-known, waxed in various colors, flower bulbs of the type amaryllis;

FIG. 2A and FIG. 2B show various representations of a well-known and well-established method of waxing products;

FIG. 3 is a view of a relatively small tulip bulb and its way of sprouting; and

FIG. 4 is a perspective top view of a possible embodiment of an arrangement according to the invention, in particular for carrying out the method according to the invention;

FIG. 5 is a schematic representation of a possible alternative embodiment of an arrangement according to the invention.

### DETAILED DESCRIPTION

FIG. 1 illustrates in a perspective view nine known waxed bulbs of the type Amaryllis, which are offered commercially in different colors. The known waxed flower bulb is dipped all around in the wax and free of wax on the upper side, i.e. the flower or sprouting side. FIG. 1 furthermore illustrates that the amaryllis bulb also exhibits a healthy and strong sprouting when waxed.

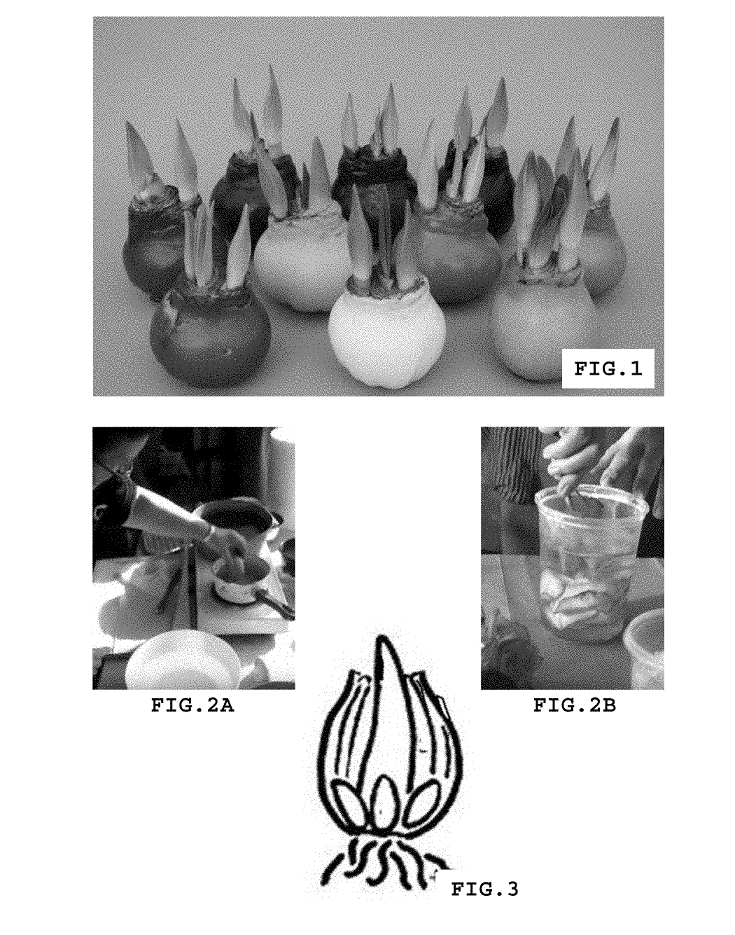

FIG. 2A illustrates the principle of dipping objects in paraffin, which consists of dipping the to be waxed object in a container, here a pan on the electric hot plate, and the immediately thereafter dipping into an adjacently disposed container with cold liquid of the previously in hot wax dipped part of the object to be waxed. FIG. 2 illustrates the hot part of this process, wherein in a flower is grabbed at the stem or sprout for immersion.

With the bulbs offered as in FIG. 1, the root part is cut away from the crop as well as the outgrowth, at least the leaf thereof. The bulbs harvested in that way are usually stored cold for some time before being possibly waxed and offered in the store or on the Internet.

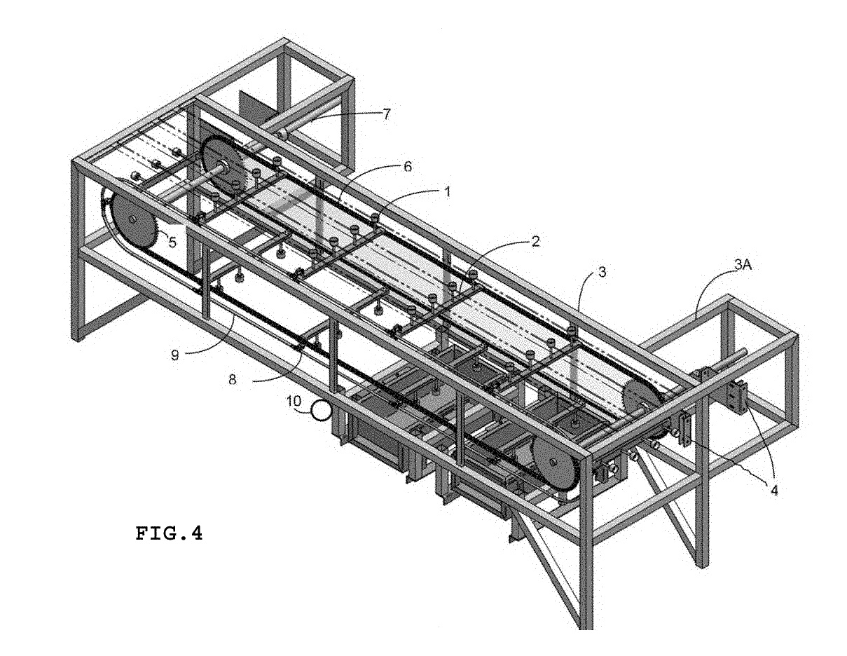

FIG. 3 illustrates schematically a waxed bulb according to the invention, such as a tulip bulb, wherein the root zone of the bulb is kept preferably as much as possible free of solidified paraffin.

At the top of the bulb, i.e. on the side of the spout, the paraffin can be applied in a minor, non-disturbing amount. The paraffin may be scraped off the top of the bulb during production, in particular when the bulb was kept upside down, more particularly after the bulb has been immersed in the wax “upside down”.

The waxed bulb according to the invention enables sprouting while allowing roots to grow. It is found that especially in crops having a small sized flower bulb, for a good chance of a beautiful, strong sprouting, or avoiding the risk of so-called emergency run, it is necessary to enable obtaining additional nutrition by allowing root growth.

The zone in a bulb kept free of wax according to the present invention generally has an at least substantially regular circular shape, in particular such as may be the case with engagement with the aid of a suction cup or the ring of a cylinder end part.

The invention also includes a method of obtaining such a novel waxed bulb, in particular for providing a flower bulb with a layer of sealant such as a paraffinic layer, wherein the bulb is engaged such that at least a part, preferably the largest part of the bulb's root zone, remains free of sealant when immersed. Hereto, the bulb may be grabbed under application of a suction cup, and the bulb is immersed into sealant such that at least the grabbed portion of the bulb remains free of sealant or wax, typically paraffin.

The suction cup may be connected to a mechanical suction of air, in particular to a under pressure created by an air pump, and hereby the bulb is manually or mechanically applied to a suction cup. The bulb and suction cup are then manually or with the aid of a rotating mechanism, for the purpose of immersion into sealant, jointly turned in such a way that the bulb is passed upside down through the bath, or at least is immersed therein.

Preferably, shortly after the first immersion a second immersion takes place to ensure a sufficiently thick and contiguous layer. Then, the bulb is caught by a soft surface, falling out of the suction cup released by a manually or automatically operated interruption of the air suction connected thereto, in particular by means of a valve in the vicinity of the one or more suction cups.

The soft surface is preferably formed by water. Before said catching with a soft surface and after immersion in paraffin, the bulb is immersed in cooling water while being grabbed by the suction cup. Multiple bulbs may be included in a revolving mechanism axially next to each other, at least at an axially offset. In the revolving mechanism, radially, or tangentially up to reaching the sealant as a consequence of revolving, a plurality of bulbs may be arranged in a staggered manner in the mechanism up to achieving the sealing of an engaged bulb as a result of rotation.

FIG. 4 illustrates an example of a turning mechanism according to the invention in the particular form of an immersion machine, in particular for carrying out a method according to one or more of the above discussed aspects of the method according to the invention. This machine is provided with a turning mechanism, which comprises one or more suction cups 1 for taking flower bulbs, which suction cups are contained in, and connected to one or more hollow supports 2. The machine further includes an air pump, not shown in the figure, for example a reversely operating blower or centrifugal pump, for evacuating the suction cups. Preferably, the air pump is included in the frame 3 of the machine, here on a projecting portion of the framework, in particular a portion 3A in which two axle bearings and axle bearing supports 4 are included. With such construction, a shaft may extend freely in a for recirculation reserved portion of the framework 3, here the central, at least largest and elongated frame member part. At this freely projecting shaft end portion, at least one, but preferably two pulleys 5, here gear wheels are included for a flexible, here chain-shaped revolving element 6. Between two of such wheels, in a driven manner, in the machine an endless circulating element such as a chain runs, which, in turn forms the carrier for hollow carrier 7 for one or more suction cups 1. Conform the example, the hollow supports 7 are preferably transversely thereto included in the machine and are preferably supported by two revolving elements 6.

Alternatively to the substantially tulip-shaped suction cups shown in FIG. 4, the suction cups according to the invention may also be substantially cup-shaped, i.e. with a flared end for receiving a flower bulb. According to the invention, such suction cup is supported at this end by a stiff cylinder relative to the suction cup, which is supported on the suction cup carrier. With such construction, the imposed bulb and the flared part of the suction cup are pulled to one another by vacuum pressure in a secure and virtually leak free manner, i.e. without the intake of false air against the edge of the cylinder. Such construction may similarly be used in a manual alternative to the machine device according to FIG. 4, wherein the suction cup is provided at the end of e.g. a shower-like pneumatic hose, wherein near a handle near the suction cup, for example with a pinch mounting, for the manual operation of a valve in the pneumatic conduit and for the with pneumatic under pressure manual guidance of a suction cup to a bulb to grab the latter and to manually immerse it in a wax or paraffin bath, whether or not using a second manual immersion of the bulb in a cold water bath.

The hollow carriers are closed at one end and at the other end via a to open up and to close off valve 8, here, a mechanical shutter with valve stem, connected to a circulating flexible air hose 9 for the pumping of the air out of hollow carriers whose valve is open. This opening and closing of the valves can be done in the machine automatically by arranging stops at the appropriate places in the machine, at least conductors which at passing force a valve stem in an either opened or closed position in the going around thereof. For this purpose, one of the axes of the machine can be connected to an (not shown) electric drive. Such drive, as well as the operation of the machine and the air pump, is preferably incorporated in an outwardly projecting frame part, i.e. the frame part wherein the shaft bearings 4 are included.

The air pump, through the fixed air lines, extends to the point 10 near the bottom of the frame and in the center thereof. From the central fixed point, it is via a square angled swivel coupling and by analogy of an electrical so-called cable rack, via a flexible intermediate hose connected to the circulating conduit 9, at this side also via a hooked pivotal swivel coupling. The flexible intermediate conduit, during the recirculation of conduit 9, moves in accordance with a back and forth going electrical cable chain.

At the bottom side of the frame two trays are included side by side, one of which equipped with a heating system for heating paraffin, and the other with a refreshment system for keeping a liquid cool, in this case water for the submersion of a bulb that has been dipped in paraffin before. For this purpose, in this example the two trays are incorporated in the apparatus with height adjustability. In this example, the containers are for this purpose included adjustably in height relative to the frame via pneumatically actuated adjusting cylinders. In this manner, whenever a suction cup or a row of suction cups approaches the paraffin container, the tray is moved upwardly, and again downwards, while the suction cup, supported by the bypass or recirculation element 6, continues to rotate at constant speed. Between the cooling fluid bin and the paraffin tray, in a preferred embodiment, at least one second paraffin or wax bin is included for effecting a double, i.e. second wax immersion of the flower bulb.

At the end of the bottom side circulation of a suction cup, therefore also of the recirculation element 6, or earlier after the bulb has been cooled after immersion, the valve for suction air from a suction cup or a row of suction cups is automatically actuated, such that the suction of air, at least the under pressure from the pump, stops and the bulbs automatically fall from their suction cup seat. Preferably they are caught by a soft surface.

The water tank may be, in a further embodiment, formed as an extended tray of which the water forms the intended soft surface, and in which the bulbs are taken by means of a water flow in the tank to a downstream located point where the bulbs are taken out of the extended container for further processing.

In an alternative embodiment, the cooling takes place in a dry manner by means of cold water vapor, especially via a bulb directed vapor stream, or by means of a nitrogen vapor, at least by a cold environment in or just above a vaporizing layer of nitrogen.

A further particular measure concerns the further processing of the flower bulb after the wax layer is or wax layers are applied, by pressing a ring in the wax layer, or placing a cylindrical end on the upper side, i.e. the diametrically opposite to the root center of the flower bulb, and in particular around the location of sprouting of the flower bulb. Herewith, the wax layer is not broken, but it is made thinner locally. This results in a breakable edge through which the flower bulb may break at sprouting, i.e. which can be pushed or removed as far as possible, like a hood or part of a cap which is taken out of the way, using the said ring of locally reduced thickness of wax as made by e.g. said cylinder. Such breakable edge may be created by pressing in still somewhat soft wax layer, for example before actively cooling of the wax layer, but may also be created afterwards, for example with a heated ring. Such ring, for example in the form of electrical resistance, may be included at the end of a cylinder acting as a carrier. For this purpose, an electrical and/or thermal insulation may be included between the ring and the cylinder rim. In a simple embodiment, the controllable thermal ring is included on a synthetic cylinder, so that thermal and electrical insulation is not needed.

In order to grab the bulbs to be immersed, the suction cups can thus be included via said hollow carrier or holder in pneumatic connection with the air pump. A particular finding and feature of the machine is that the connection of the suction cup or suction cup holder with the air pump, in this example via connection to the circulating flexible air duct, comprises a pipe line denotable as a swivel conduit, which is provided with a rotatable or swivel coupling for connecting the hollow carrier, in this example via the circulating conduit 9, to a fixed central pneumatic conduit connected to the air pump, with a discharge point 10.

The swivel line can be included in the machine beyond an axial end of the revolving mechanism, in particular of a physical shaft thereof. One or more hollow carriers are included in connection with a flexible circulation such as a belt or a chain running over two wheels in the machine. Herein, the suction cup holders are interconnected by a flexible pneumatic circular or bypass line which is incorporated parallel to the carrier supporting circulation. This pneumatic circulation line is connected at point 10 of the central pneumatic conduit via a flexible connecting line, which connection line is connected at both ends by a rotary coupling with the pneumatic circulation line and the central fixed conduit, respectively. For this purpose, the swivel conduit comprises a pivotal coupling, which is at least known from hydraulics, and which is here used in a pneumatically application.

The hollow carriers can be connected to the pneumatic bypass line via an adjustable valve. Hereto, the machine can be arranged such that the connection between carrier and bypass line is automatically closed off at a predetermined release point for releasing the bulb from the suction cup, which bulb was up to that point secured by under suction, and opens at a predetermined location in the recirculation, which is located in the vicinity of, and prior to passing of an application site for applying a to be submerged bulb to a suction cup. The valve can be mechanically operable by means of stops included in the machine to that end, especially in the form of guides that change a position of a valve arm.

In accordance with the example, a hollow suction cup carrier is preferably provided with a plurality of suction cups axially juxtaposed and incorporated into the machine, i.e. coupled to two parallel lap elements in the machine, via the bearings for the shaft for the pair of parallel lap element wheels are included in a part of a frame of the machine which extends axially outside of the re-circulation space of the hollow bearings. This axial side is preferably located opposite to the axial side of the circulation space where the flexible pneumatic circulation line is accommodated. An electric control and drive of a circulation wheel and of an air pump are included on the same side of the machine as the bearings for the axle of both pairs of circulation wheels.

A circulation belt for the suction cup carriers is preferably supported at least on the upper part of its circulation, between its sprocket wheels, by a guide strip which, preferably coated with removable synthetic parts.

It will be understood that the principle according to the invention may be designed in a variety of ways with a device which is adapted to the output thereof. The example of FIG. 3 can be seen as if it were in between a relatively simple single-row design and a much further automated implementation. For example, attachment with electrically operated valves can be used, or stationary dip trays can be used with a sinusoidal circulation of the suction cup holders, whereby moving through fixed-mounted containers. In a relatively simple embodiment, the dimple trays may be moved upwards with a foot-operated lever mechanism, and the suction cup holder or the suction cup holders can be connected to a central, fixed suction conduit via a swivel line which only need to be provided with a swivel joint at one end.

The arrangement according to FIG. 4 may be further described by the following characteristics:

(i) Device according to one or more of the foregoing device characteristics, wherein one or more hollow carriers of one or more suction cups are included in connection with a flexible recirculation such as a belt or chain which is passed over two rollers mounted in the device, the holders being interconnected via a flexible pneumatic bypass line which is parallel to the carrier bypass, which bypass is connected to a central pneumatic conduit via a flexible connecting conduit, which connecting conduit is at both ends connected via a swivel coupling to respectively the pneumatic bypass line and the central fixed pneumatic line;

(ii) Device according to one or more of the foregoing device characteristics, wherein the hollow carriers are included with the bypass conduit via a controllable valve. Device according to the foregoing device characteristic, wherein the device is arranged such that the connection between carrier and bypass conduit is automatically closed at a predetermined actuating point for loosening of the bulb from the suction cup, and opens at a predetermined point in the bypass which located in the vicinity of and prior to passing an application site for applying a bulb to be immersed to a suction cup.

(iii) Device according one of the foregoing device characteristics, wherein the valve is mechanically operable by means of stops arranged in the device, in particular in the form of guides which change the position a valve arm;

(iv) Device according to one or more of the foregoing characteristics, wherein a carrier is provided with a plurality of axially juxtaposed suction cups and is included in the device via two parallel arranged recirculation bypasses, and wherein the bearings for the shaft for a pair of parallel sprocket wheels are included in a part of a frame of the device which extends axially outside of the circulation space of the hollow bearings;

(v) Device according to the foregoing characteristics, wherein the axial side is situated opposite to the axial side of the circumference where the flexible pneumatic bypass conduit is accommodated;

(vi) Device according to the foregoing characteristics, wherein an electric drive and drive of a reversing wheel and of an air pump are included on the same side of the device as the bearings for the axle of both pairs of roller or sprocket wheels.

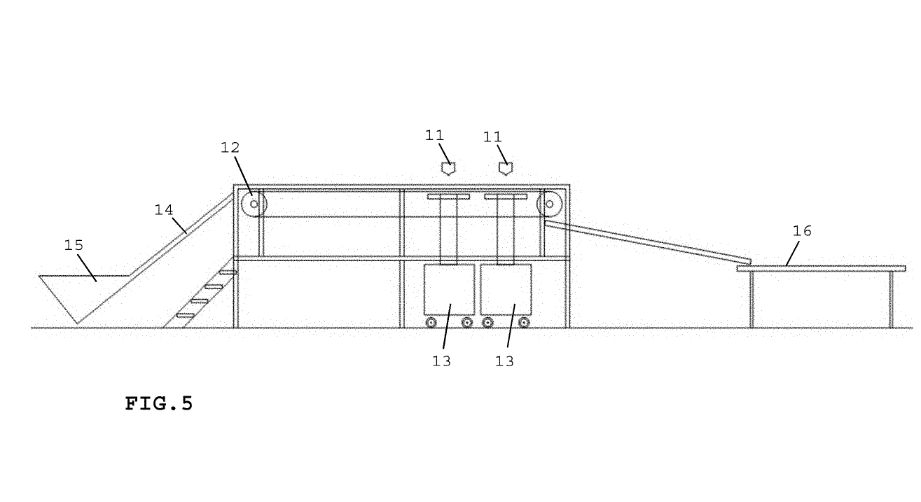

FIG. 5 shows an alternative embodiment of an arrangement for performing the waxing method according to the invention. Herein, previously mentioned cylinders are fixed to an open, for example gauze-shaped circular belt 12 and the bulbs 11 are placed on the cylinder, wherein the cylinder has a diametric dimension that completely surrounds the root surface of the bulb, thus covering the flower bulb preventing it to become entirely waxed. While circulating the belt the bulbs are carried under a curtain-shaped stream of wax. The wax which does not land on the bulb, or which has not been left behind, is collected beneath the belt and taken away, i.e. recycled to paraffin bins 13 that are in this example incorporated below the belt.

In FIG. 5, to this end there is provided a feed conveyor 14 which raises the bulbs from a hopper 15 to the above-mentioned bypass or circulation belt 12, at which location these are automatically or manually placed on the cylinders. After passing the wax station, in this example at the circulation end of belt the bulbs fall off the cylinder and are caught in a collector arrangement such as a water tank, or as shown here the runway that guides the bulbs to a table 16.

In the embodiment of FIG. 5, features may be included such as a cooling device incorporated above the circulation belt, for example on the basis of cold air, water vapor or nitrogen vapor, and a second wax layer may be applied by means of a second wax station included further down the line of the circulating belt.

The facilities may include a stripping device, for example in the form of a scraper which scrapes the wax of the upper side, i.e. from the sprouting point of the bulb, or a knife or saw which provides a comparable facilitating of the outgrowth of the flower pole by minimalistic shortening of the sprouting tip. Rather than a scraper or knife or saw, the provision may also include that the wax layer is weakened around the bulb's sprout point, for example by slightly damaging or dilution, at least forms a hood. This can be pressed away during the growth, for example, by the bulb or plant itself, so that the bulb may with certainty encounters no hindrance or at least is minimally affected by the wax layer faced at sprouting, or that the quality and value of the waxed bulb according to the invention is thus increased even further.

In an embodiment, the invention comprises a bulb, as well as method for the production thereof, which, in addition to the keeping free of wax of part of the lower side (root side), is provided at the upper side with at least one of a cut-off part, a scraped off growing point, and a facility introduced into the wax around the growing point which causes a flip-off cap at the growth point.

The invention may, on the basis of the above, further be characterized by one or more of the following embodiments of methods and devices:

(i) Method to provide a bulb with a layer of wax, wherein the bulb is placed on a ring or on the end of a cylinder, wherein the bulb is topped with a stream of wax;

(ii) Method as described above, wherein the root circle of the bulb is located within the diameter of the cylinder when placing the bulb on the cylinder;

(iii) Method as described above, wherein the stream is formed by flowing it over a preferably straight blade edge;

(iv) Method as described above, wherein the stream as poured over the bulb is curtain shaped;

(v) Method as described above, wherein flower bulb and the blade edge, at least the stream of wax, move relative to each other;

(vi) Method as described above, wherein the ring is contained on a mesh-shaped supporting surface, preferably in such a way that excess wax may freely flow through this support surface;

(vii) Method as described above, wherein the mesh-shaped supporting surface is flexibly formed by a circumferential, preferably industrial, mesh or chain mat;

(viii) Method as described above, wherein the supporting surface is at least locally heated;

(ix) Method as described above, wherein the heater is formed by a stream of air;

(x) Method as described above, wherein the ring is heated and thermally separated included at the end of a cylinder;

(xi) Method as described above, wherein the cylinder is coupled to the circumferential mat;

(xii) Method as described above, wherein the bulb in the circulation of the mat falls off by force of gravity, or is mechanically lifted thereof, and is thereby included in a collecting unit;

(xiii) Method as described above, wherein the flower bulb is, with small interval of time, poured over two times, in particular two times by a curtain like flow of wax, more particularly using two blade edges which are included one behind the other with respect to one and the same circulating surface;

(xiv) Apparatus, for example in whole or in part according to the preceding description of figures, however at least arranged to carry out a method as above described.

The present invention, apart from what has been described above, also relates to all details in the figures, at least for as far as these are directly and unambiguously derivable by a skilled person, and to what that is described in the following set of claims.

1. A flower bulb, for example hyacinth, tulip and daffodil, provided with a wax layer, in particular a colored wax layer, wherein the bulb at least near root area thereof, shows a zone that is kept free of wax.

2. The flower bulb according claim 1, wherein the cut-off at the top of the bulb is scraped off, at least located at the upper side is provided with a relatively thin layer of wax.

3. The flower bulb according to claim 1, wherein the zone that is kept free at least for the largest part coincides with the root zone of the bulb.

4. The flower bulb according to claim 1, wherein the zone that is kept free typically has an at least substantially regular circular shape, in particular such as may be the case by grabbing with aid of a suction cup.

5. The flower bulb according to claim 1, wherein the wax layer is processed at the top end of the bulb, in particular on or around the sprout point of the bulb is provided with a weakening of the wax layer.

6. A method for providing flower bulbs with a layer of sealant like a paraffin layer, wherein a root zone of a flower bulb is kept free from sealant by a grabbing means, such as with grabbing by a suction cup or a ring such as of an upright standing cylinder, wherein the grabbing means take up the root zone, at least cover the root zone, such that at immersion in or with sealant the root zone remains free from sealant.

7. The method according to claim 6, wherein the bulb is engaged such that at least a part of the root zone of the bulb at immersion remains free of sealant.

8. The method according to claim 6, wherein the suction cup is connected to a mechanical air suction, in particular to an under pressure created by ab air pump.

9. The method according to claim 6, wherein the bulb is manually or mechanically applied to a suction cup.

10. The method according to claim 6, wherein the suction cup is surrounded and near its outer edge supported by a cylindrical holder, at least support to the suction cup.

11. The method according to claim 6, wherein the bulb and suction cup, either manually or mechanically, in particular by means of a turning mechanism, for the purpose of immersion in sealant are jointly turned so that the bulb is passed upside down through a bath, or at least is immersed therein.

12. The method according to claim 6, wherein the bulb while caught by a soft surface, is released falling by interruption of air suction.

13. The method according to claim 12, wherein the soft surface is formed by, at least wherein the catching is performed with water, in particular cooling water.

14. The method according to claim 12, wherein the bulb before being caught by said soft surface and after immersion in paraffin, under continuous engagement by the suction cup is brought into immersion of cooling water.

15. The method according to claim 6, wherein a plurality of bulbs are included axially next to each other, at least axially staggered in the rotating mechanism.

16. A device for waxing of flower bulbs, especially for carrying out a method according to claim 6, which device comprises wax application means for immersion of bulbs in or with wax, and which device is provided with one or more ring shaped free from wax retaining elements for receipt therein of the root circle of the bulb, such as a suction cup or the end of a cylinder, in particular for keeping the root zone of the bulb free of wax during the waxing thereof.

17. The device according to claim 16, which device is provided with one or more suction cups for grabbing a flower bulb, said device further comprising an air pump for evacuating the suction cups, said suction cups for this purpose being included in pneumatic connection with the air pump.

18. The device according to claim 16, wherein the suction cup is included in a relatively rigid cylinder, such that an end of the cylinder supports the suction cup near a radial outer end thereof during operation.

19. The device according to claim 17, wherein in the pneumatic connection is included a controllable valve.

20. The device according to claim 17, wherein the device comprises a turning mechanism, and wherein the pneumatic connection comprises a rotary coupling for pneumatically connecting, via a pivotable conduit or holder part, the suction cup with a central, fixed pneumatic line, connected to the air pump.

21. The device according to c1aim 20, wherein the conduit or holder part in the apparatus is included in the device beyond an axial end of the rotating mechanism, in particular of a physical axis thereof.
